(19) United States
(12) Patent Application Publication
(10) Pub. No.: US 2025/0317874 A1
(43) Pub. Date: Oct. 9, 2025

(54) TIME SYNCHRONISATION ACROSS A NETWORK

(71) Applicant: SAT-COM (PTY) LTD, Windhoek (NA)

(72) Inventors: Maarten Venter, Windhoek (NA); David Kenneth Brown, Windhoek (NA)

(21) Appl. No.: 18/866,005

(22) PCT Filed: May 16, 2023
(86) PCT No.: PCT/IB2023/055023

§ 371 Date: Nov. 14, 2024

(30) Foreign Application Priority Data
May 17, 2022 (GB) 2207200.3

(51) Int. Cl. H04W 56/00

(52) U.S. Cl. CPC H04W 56/001

(57) ABSTRACT

An apparatus, system and method for time synchronisation across a network are provided. The apparatus includes a configuration receiving component for receiving configuration of the apparatus to monitor a synchronisation event selected from: a time-based event; and, an operation-based event. The apparatus includes a configuring component for configuring the apparatus to monitor the selected synchronisation event. The apparatus includes an occurrence detecting component for detecting occurrence of the synchronisation event and a synchronisation information transmitting component for, in response to detecting occurrence of the synchronisation event, transmitting synchronisation information usable for time synchronisation by another apparatus. A system including a number of apparatuses is also provided.

### CROSS-REFERENCE TO RELATED APPLICATIONS

This application claims priority from United Kingdom patent application number 2207200.3 filed on 17 May 2022, which is incorporated by reference herein.

### FIELD OF THE TECHNOLOGY

The invention relates to time synchronisation of apparatuses across a network, such as a radio network.

### BACKGROUND

Frequency hopping, or “frequency-hopping spread spectrum” (FHSS) typically refers to a method of transmitting radio signals by rapidly changing the carrier frequency among many distinct frequencies occupying a large spectral band. The available spectral band may be divided into smaller sub-bands, and signals may for example rapidly change their carrier frequencies among the centre frequencies of these sub-bands in a specific or predetermined order. The changes are typically controlled in a manner that is known to both a transmitting and a receiving apparatus only. In this manner, interference at a specific frequency will only affect the signal during a short interval.

FHSS can be useful in avoiding interference and in preventing eavesdropping. In military applications, for example, FHSS signals can be resistant to deliberate jamming, unless the adversary has knowledge of the frequency-hopping pattern. Military radios typically generate the frequency-hopping pattern under the control of a secret key (such as a so-called Transmission Security Key, “TRANSEC” in some applications) that the sender and receiver share in advance.

For frequency hopping to be effective, transmitting and receiving apparatuses engaging in frequency hopping within a secure network must share a single time reference within the network. However, because apparatuses are susceptible to clock drift and apparatuses outside of the network do not share a singular time reference with apparatuses within the network, apparatuses must be synchronised to enter and remain in the network.

One of the challenges of frequency-hopping systems involves synchronising the required apparatuses in a manner which allows new and drifting apparatuses to synchronise quickly without also unduly increasing exposure to attack by jammers and direction finders.

The applicant considers there to be scope for improvement.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY

In accordance with an aspect of the invention there is provided an apparatus comprising: a configuration receiving component for receiving configuration of the apparatus to monitor a synchronisation event selected from: a time-based event; and, an operation-based event; a configuring component for configuring the apparatus to monitor the selected synchronisation event; an occurrence detecting component for detecting occurrence of the selected synchronisation event; and, a synchronisation information transmitting component for, in response to detecting occurrence of the selected synchronisation event, transmitting synchronisation information usable for time synchronisation by another apparatus.

In this manner, different apparatuses in the field can receive different configuration. The configuration receiving component may receive the configuration from a user. The user may be a network user having network access to a plurality of apparatuses including the apparatus or an operator of the apparatus who is physically before the apparatus.

The apparatus may further include: a synchronisation information receiving component for receiving synchronisation information usable for time synchronisation; and, a synchronising component for synchronising a local clock based on the received synchronisation information. The operation-based event may include a transmission event. The transmission event may include a communication transmission via a transceiver. The time-based event may include a time interval event. The configuring component may configure the apparatus to monitor a period of time associated with the time interval event. The configuration receiving component may be further arranged to receive configuration of a period of time associated with the time interval event. The occurrence detecting component may be further arranged to detect that the period of time associated with the time interval event has expired.

The apparatus may include a timer for detecting the expiry of the period of time associated with the time interval event, wherein the timer repeatedly times the period of time. The synchronisation information may be included in a time synchronisation packet. The time synchronisation packet may include an authentication vector configured for verification.

Transmitting the synchronisation information may include transmitting the synchronisation information via one or more synchronisation channels. The one or more synchronisation channels may be discrete from a hop channel via which radio communication transmissions are transmitted or received.

In accordance with a further aspect of the invention there is provided a system including two or more apparatuses as previously described, wherein a first apparatus of the two or more apparatuses is configured to monitor a time-based event and wherein a second apparatus of the two or more apparatuses is configured to monitor an operation-based event.

The system may include a third apparatus configured to monitor a time-based event and an operation-based event. The system may include a fourth apparatus, wherein the fourth apparatus may be configured to monitor a time-based event, and wherein: the first apparatus receives configuration of a first period of time associated with the time interval event; and, the fourth apparatus receives configuration of a second period of time associated with the time interval event, wherein the first and second periods of time are different.

In accordance with a further aspect of the invention there is provided a computer-implemented method comprising: receiving configuration of an apparatus to monitor a synchronisation event selected from: a time-based event; and, an operation-based event; configuring the apparatus to monitor the selected synchronisation event; detecting occurrence of the selected synchronisation event; and, in response to detecting the occurrence of the selected synchronisation event, transmitting synchronisation information usable for time synchronisation by another apparatus.

The method may include receiving the configuration from a user. The user may be a network user having network access to a plurality of apparatuses including the apparatus or an operator of the apparatus who is physically before the apparatus.

The operation-based event may include a transmission event. The transmission event may include a communication transmission via a transceiver. The time-based event may include a time interval event. The method may include configuring the apparatus to monitor a period of time associated with the time interval event. The method may include receiving configuration of a period of time associated with the time interval event. Detecting occurrence of the selected synchronisation event may include detecting that the period of time associated with the time interval event has expired. Detecting that the period of time associated with the time interval event has expired may include using a timer which repeatedly times the period of time.

The synchronisation information may be included in a time synchronisation packet, wherein the time synchronisation packet may include an authentication vector configured for verification. The method may include authenticating the synchronisation information or packet using the authentication vector. Authenticating may include extracting the authentication vector from the packet. Authenticating may include calculating an authentication vector using one or both of a key and a hashing algorithm. Calculating the authentication vector may include encrypting the random number using the key. Calculating the authentication vector may include performing a hash operation on the random number using the hash algorithm. Calculating the authentication vector may include performing a hash operation on the random number having been encrypted using the key. Authenticating may include comparing the extracted vector to the calculated vector. If the extracted authentication vector does not match or correspond to the calculated authentication vector, the synchronisation information or packet is not authenticated and the method may include ignoring or discarding the information or packet. If the extracted authentication vector does match the calculated authentication vector, the authentication vector may be authenticated and the method may include synchronising a local clock based on the received synchronisation information. In some cases, authenticating may include comparing the extracted authentication vector to vectors stored in memory. If the extracted authentication vector matches or corresponds to any of the authentication vectors stored in memory, the synchronisation information or packet is not authenticated and the method may include ignoring or discarding the information or packet.

If the extracted authentication vector does not correspond to any stored values, the authentication vector is authenticated and the method may include synchronising a local clock based on the received synchronisation information. The method may include storing the authentication vector so that once an authentication vector is stored it cannot be used again. Authenticating may include checking a time and/or date stamp included in the synchronisation information or packet and comparing this to the current time and/or date to prevent old messages from being used for synchronisation. Authenticating may include confirming an authentication vector as verified if one or more of the following conditions are met: the calculated and extracted authentication vectors match; and, the extracted authentication vector has not previously been stored in memory.

The method may further include transmitting the synchronisation information via one or more synchronisation channels. The one or more synchronisation channels may be discrete from a hop channel via which radio communication transmissions are transmitted or received.

Embodiments of the technology will now be described, by way of example only, with reference to the accompanying drawings.

### BRIEF DESCRIPTION OF THE DRAWINGS

In the drawings:

FIG. 1A is a schematic diagram which illustrates an exemplary embodiment of a system for time synchronisation across a network according to aspects of the present disclosure;

FIG. 1B is a block diagram illustrating exemplary components of an apparatus according to aspects of the present disclosure;

FIG. 2 illustrates an exemplary structure of a time synchronisation packet according to aspects of the present disclosure;

FIG. 3 is a flow diagram which illustrates exemplary steps for configuring an apparatus according to aspects of the present disclosure;

FIG. 4A is a flow diagram which illustrates an exemplary method for time synchronisation across a network according to aspects of the present disclosure;

FIG. 4B is a flow diagram illustrating exemplary steps in a method performed by an apparatus in synchronisation transmitting mode for synchronising an apparatus in synchronisation receiving mode according to aspects of the present disclosure;

FIG. 4C is a flow diagram illustrating exemplary steps in a method performed by an apparatus in synchronisation receiving mode according to aspects of the present disclosure;

FIG. 5 illustrates an exemplary sequence of transmitting operations according to aspects of the present disclosure;

FIG. 6 illustrates an exemplary sequence of operations by an apparatus awaiting synchronisation information according to aspects of the present disclosure;

FIG. 7 illustrates an exemplary embodiment of a system according to aspects of the present disclosure;

FIG. 8 illustrates a second exemplary embodiment of a system according to aspects of the present disclosure; and

FIG. 9 illustrates a third exemplary embodiment of a system according to aspects of the present disclosure.

### DETAILED DESCRIPTION WITH REFERENCE TO THE DRAWINGS

Aspects of the present disclosure provide an apparatus, system and method for time synchronisation, which may be termed Over-The-Air-Hopping-Synchronisation (OTAHS). OTAHS protocol according to the present disclosure may be implemented in the apparatus, which may be configurable according to a number of configuration parameters. The apparatus may be a radio, a software defined radio, or the like. Providing an apparatus with flexible configuration, such that different apparatuses may receive different configuration in the field, may allow diverse networks to be established having characteristics which may limit the network's exposure to jamming or detection by direction finders while allowing for synchronisation when network activity is low. The apparatus described herein may be a multi-role apparatus which can take on different roles depending on configuration thereof. The configuration may be received from a user, such as an operator of the apparatus or a remote network user. The configuration may be received in the field and may be changed in the field based on changing operational requirements.

The apparatus may operate in a synchronisation transmitting mode or in a synchronisation receiving mode, depending on configuration and/or the current role of the apparatus within the time synchronisation. An apparatus operating in a synchronisation transmitting mode is termed a “synchronisation transmitting apparatus” herein. An apparatus operating in a synchronisation receiving mode is termed a “synchronisation receiving apparatus” herein. In some configurations, the apparatus may switch between these modes. It should be appreciated that the same apparatus may be a synchronisation transmitting apparatus in a first time synchronisation and a synchronisation receiving apparatus in a second time synchronisation, and so forth. In some embodiments, the apparatus may be configured solely as a synchronisation transmitting apparatus (e.g., in an embodiment where there is only one synchronisation transmitting apparatus) or solely as a synchronisation receiving apparatus.

A synchronisation transmitting apparatus receives configuration to monitor a synchronisation event selected from: a time-based event; and, an operation-based event (which can include receiving configuration to monitor both time-based and operation-based synchronisation events). This configuration may be received in the field, for example from an operator prior to deployment for a mission, during a mission, etc. The synchronisation transmitting apparatus detects occurrence of the synchronisation event. In response to detecting occurrence of the synchronisation event, the apparatus transmits synchronisation information usable by another apparatus, such as a synchronisation receiving apparatus, for time synchronisation. Synchronisation information may also be termed “synchronisation timing”, “timing,” “timing information”, or the like.

A synchronisation receiving apparatus receives synchronisation information usable by the synchronisation receiving apparatus for time synchronisation. The synchronisation receiving apparatus synchronises a local clock based on the received synchronisation information.

In this manner, a role of an apparatus in network timing synchronisation may be configurable as a hailer, master, master-hailer and slave. Specifically, an apparatus that receives configuration to monitor a time-based event performs a hailer role; an apparatus that receives configuration to monitor an operation-based event performs a master role; and an apparatus that receives configuration to monitor both a time-based event and an operation-based event performs a master-hailer role. An apparatus that receives configuration only to receive synchronisation information (and not to transmit it) performs a slave role. As will be explained in greater detail below, this role configurability may enable space and time diversity in a radio network which balances faster late entry against exposure to jamming and direction finding by an adversary. It may also allow apparatuses to be reconfigured to different roles while in the network, as needed. Further, different apparatuses may be configured differently depending on whether or not they are manned, for example, which may reduce fatalities in a combative environment.

In one example embodiment, a hailer is an apparatus that transmits synchronisation information to other apparatuses at predetermined intervals (this type of transmitting may also be called hailing). The hailer is configured to monitor as a synchronisation event a time-based event (for example, the expiry of a time period, the timing of which may repeat). When operating as a synchronisation receiving apparatus, the hailer receives synchronisation information from other hailers, master-hailers and/or masters. A hailer may be suitable for unmanned operation.

In one example embodiment, a master is an apparatus that transmits synchronisation information to other apparatuses after a communication transmission and not at predetermined intervals. The master is configured to monitor as a synchronisation event an operation-based event, such as a transmission event (for example, a communication transmission). When operating as a synchronisation receiving apparatus, the master receives synchronisation information from other hailers, master/hailers and/or masters.

A communication transmission as used herein may be an operator-initiated transmission of information. A communication transmission may include sending voice or text communications, which may be encoded and/or encrypted, for receipt by operators of other apparatuses in the network. A communication transmission may therefore be an operator-to-operator communication transmission.

In one example embodiment, a master-hailer is an apparatus that transmits synchronisation information to other apparatuses both at predetermined intervals and after communication transmissions. The master-hailer is therefore configured to monitor as a synchronisation event both a time-based event and an operation-based event. When operating as a synchronisation receiving apparatus, the master-hailer receives synchronisation timing from other hailers, master-hailers and/or masters.

In one example embodiment, a slave is an apparatus that receives synchronisation information from other hailers, master/hailers or masters but does not transmit synchronisation information to other apparatuses.

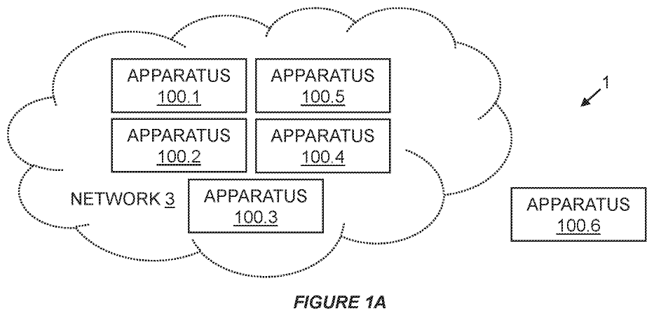

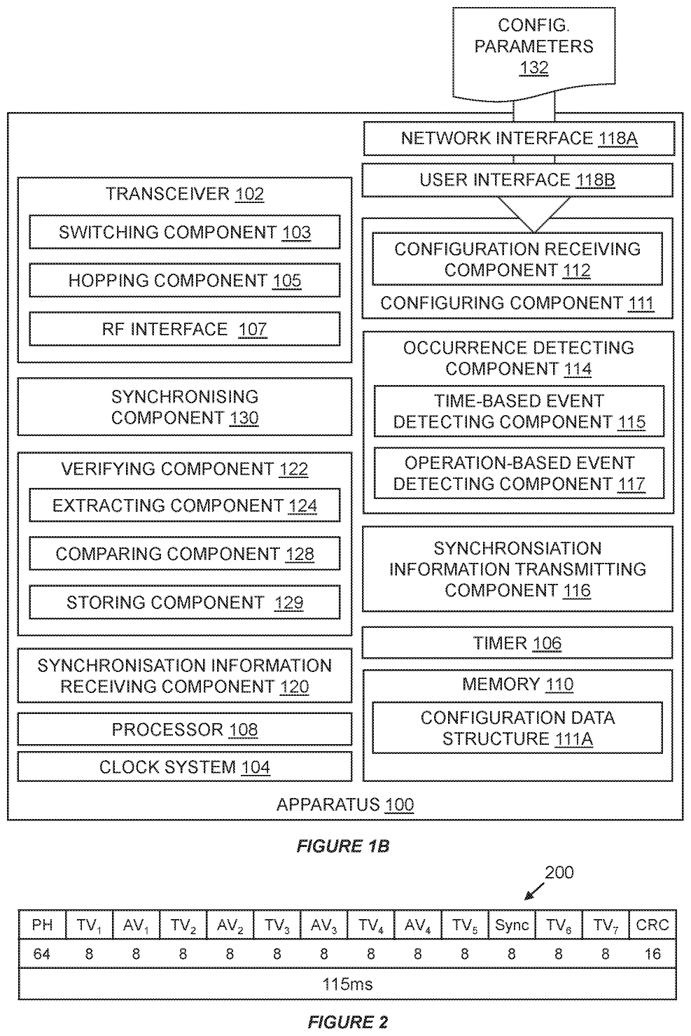

A plurality of apparatuses may collectively form a system. One example embodiment of a system (1) for time synchronisation across a network is illustrated in FIG. 1A. The system (1) includes a plurality of apparatuses (100.1, 100.2, 100.3, 100.4, 100.5, 100.6). Configured apparatuses which are considered synchronised may form a network (3). An apparatus within the system (1) may enter or “lock into” the network (3) by receiving synchronisation information, synchronising its local clock and initiating frequency hopping for transmitting and receiving communication transmissions based on the synchronised local clock and other relevant parameters. Apparatuses within the system (1) may transmit and receive communication transmissions via a hop channel. The hop channel may change according to a randomized hop pattern. An apparatus may leave, be removed from or “locked out of” the network (3) upon expiry of a time period associated with a timeout setting. The timeout setting may be included in the configuration.

Different apparatuses within the system (1) may be configured differently. For example, a first apparatus (100.1) may be configured to monitor a time-based event. Such an apparatus may be termed a “hailer”. A second apparatus (100.2) may be configured to monitor an operation-based event. Such an apparatus may be termed a “master”. A third apparatus (100.3) may be configured to monitor both a time-based event and an operation-based event. Such an apparatus may be termed a “master-hailer”.

It should be appreciated that in a system which includes two or more apparatuses configured to monitor a time-based event which is a time interval event, different apparatuses may be configured or receive configuration of different periods of time associated with the time interval event. The system may, for example include a fourth apparatus (100.4) which is configured to monitor a time-based event. The first apparatus (100.1) may receive configuration of a first period of time associated with a time interval event; and the fourth apparatus (100.4) may receive configuration of a second period of time associated with a time interval event. The first and second periods of time may be different. That is, the periods of time associated with the time interval event need not be the same for each apparatus within the system.

The system may further include an apparatus (100.5) that is configured as a slave that receives synchronisation information from other apparatuses in the network (3).

An apparatus (100.6) which has been configured but has not yet received time synchronisation information, or has not recently received time synchronisation information, may be part of the system (1) but not part of the network (3). The apparatus (100.6) may become part of the network (3) upon synchronising its local clock.

Including apparatuses of different configurations and/or adjusting configurations within the network may provide a more flexible system that can recover more quickly from damage. For example, existing slave apparatuses according to the present disclosure may be reconfigured to masters, hailers, or master-hailers if existing masters, hailers, or master-hailers are lost or damaged. Including a variety of masters, master-hailers and hailers may also help to distribute (or partially mitigate) risk to equipment and personnel operating the apparatuses.

FIG. 1B is a block diagram illustrating exemplary components of an apparatus (100) according to aspects of the present disclosure. The apparatus (100) may include a transceiver (102) for receiving and transmitting information and/or data via signals, such as radio-frequency signals. The transceiver may be a wireless transceiver and may interface with an antenna via which the signals are transmitted and received. The transceiver (102) may include a switching component (103) for switching between one or more synchronisation channels and a hop channel.

The transceiver (102) may include a hopping component (105) for changing the hop channel. Changing the hop channel may include altering the centre frequency of the hop channel. The hop channel may be changed according to a randomized hop pattern. The hopping component (105) may use a clock system (104) for synchronisation of the hop pattern with the hop pattern of other apparatuses in the network such that each of the apparatuses transmits or receives communication transmissions on the same hop channel at the same point in time. If the clock system of the apparatus is not synchronised with that of other apparatuses, transmitting and receiving communication transmissions may be ineffective.

The switching and hopping components (103, 105) may be implemented by the same or different hardware. The transceiver may further include a radiofrequency (RF) interface (107) for interfacing with the antenna for receiving and transmitting radio signals.

The apparatus (100) may include the clock system (104). The clock system (104) may include an oscillator. The oscillator may be a high precision oscillator. In some example embodiments, the oscillator may have a frequency stability of between −50 to +50 parts per billion (ppb) and a clock drift of 180 microseconds (μs) per hour. The clock system (104) may require synchronisation. The apparatus (100) may further include one or more timers (106).

The apparatus (100) may also include a processor (108) for executing the functions of components described below, which may be provided by hardware or by software units executing on the apparatus (100). The software units may be stored in a memory component (110) and instructions may be provided to the processor (108) to carry out the functionality of the described components.

Exemplary components of the apparatus (100) may include a configuring component (111), an occurrence detecting component (114) and a synchronisation information transmitting component (116). The configuring component (111) may include a configuration receiving component (112).

The apparatus (100) may further include a configuration interface which may include one or both of a network interface (118A) through which a network user may input configuration parameters (132) from a remote location via a communication network and a user interface (118B) through which an operator of the apparatus may input configuration parameters (132).

The configuring component (111) may be arranged to configure the apparatus (100). The configuration receiving component (112) may be arranged to receive configuration of the apparatus (100) in the form of configuration parameters (132). Receiving configuration of the apparatus (100) may include receiving configuration from a user. Configuring may be according to configuration received by the configuration receiving component (112). Configuring may instruct the apparatus to switch between a communication mode and one or both of a synchronisation transmitting mode and a synchronisation receiving mode, based on detection of events or timeouts, as will be described in greater detail below. Configuring may instruct the apparatus (100) to monitor a synchronisation event selected from: a time-based event; and an operation-based event, depending on its configured role.

A time-based event may include a time interval event. Configuring may include configuring a period of time associated with the time interval event. The period of time may, for example, indicate the amount of time between time interval events or the amount of time between transmissions of synchronisation information. The configuration receiving component (102) may therefore be configured to receive configuration of a period of time associated with the time interval event.

An operation-based event may include a transmission event. The transmission event may, for example, include a communication transmission via the transceiver (102).

Configuring may be according to various parameters. The parameters may be network setup parameters. Values for the parameters for at least some apparatuses in a system may be predetermined by a user before a network is established and/or becomes operational.

Exemplary parameters include: role; period of time associated with the time interval event (also called a hailing transmission interval); synchronisation channel(s); offset; timeout enable/disable and multiple/single number of transmitters. Exemplary options for each of the network setup parameters are shown in Table 1.

TABLE 1
Configuration parameters

| PARAMETER | OPTIONS |
|---|---|
| Role | hailer, master-hailer, master, slave |
| Time Period | 5, 15, 30, or 60 minutes |
| Offset | 5-minute hail time → 5 intervals, e.g., 0, 1, 2, 3, 4 |
| | minutes |
| | 15, 30, or 60-minute hail time → 15 intervals, e.g., for a |
| | 30-minute hail time: 0, 2, 4, 6 . . . 28 minutes |
| Channels | freq1, freq2, freq3, freq4, freq5, freq6, freq7, freq8 |
| Timeout | enabled, disabled |
| Number of | multiple, single |
| Transmitters | |

The role refers to which type of synchronisation event the apparatus must monitor, or if it is solely a synchronisation receiving apparatus. Possible roles include hailer, master-hailer, master and slave apparatuses as previously described.

The period of time associated with the time interval event, or “hailing transmission interval” may, for example refer to the time period between each transmission of synchronisation information or between each time-based event. A synchronisation event may include for example an expiry of a timer (106).

Synchronisation channel(s) refers to the frequency or frequencies at which the apparatus (100) may transmit and/or receive synchronisation information. The apparatus (100) may be configured to transmit the synchronisation information via one or more synchronisation channels. The one or more synchronisation channels may be discrete from a hop channel via which radio communications are transmitted or received. The one or more synchronisation channels may be randomly generated and may thus not be predictable to other parties.

In an embodiment where a synchronisation transmitting apparatus is configured for eight synchronisation channels, for example, the synchronisation transmitting apparatus may transmit the synchronisation information at least once across each channel (i.e. at least eight times). In an exemplary embodiment where an apparatus is configured for eight synchronisation channels, the apparatus may poll each of the eight channels for synchronisation information. Polling may occur continuously until valid synchronisation information is received. The synchronisation information may be transmitted and/or received via the transceiver (102).

The offset refers to a random time offset from the time stamp of a synchronisation event. When transmitting synchronisation information responsive to detection of a synchronisation event, such as a time-based event, the apparatus (100) may do so at the time offset. The offset may be associated with a time interval event and/or the period of time associated with the time interval event. The allowable number of potential offsets may be configured. In some embodiments, the allowable number of potential offsets may be derived from other information, such as from other parameters or from the transmission duration. In an embodiment, if the period of time associated with the time interval event is five minutes and five potential offsets are allowable, the apparatus may be configured to transmit synchronisation information (with the time interval event denoted here as t) at t+0, t+1, t+2, t+3, or t+4 minutes. In another embodiment, if the period of time associated with the time interval event is 30 minutes and 15 potential offsets are allowable, the apparatus may be configured to transmit synchronisation information (with the time interval event again denoted as t) at t+0, t+2, t+4 . . . t+28 minutes.

The synchronisation timeout is associated with the point at which an apparatus leaves its network. In some embodiments, the timeout may be a time stamp. In other embodiments, it may be a time period. The timeout may refer to the time the apparatus takes to initiate resynchronisation after it has been synchronised (or, put differently, the period of time for which it will remain synchronised before locking out of the network). Thus, the apparatus may wait the timeout period after synchronisation before locking itself out of the network. Thereafter the apparatus needs to be resynchronised in order to return to the network. Resynchronisation may require receiving synchronisation information from a master, hailer or master-hailer. The timeout may be dependent on the hop rate.

When the synchronisation timeout is enabled, the apparatus may automatically calculate the timeout period and enable the feature. The timeout may be calculated according to the following equation, with timeout period, T, in seconds and hopᵣₐₜₑ in Hertz:

$$T = \frac{180 \cdot 2400 \cdot 2}{{hop}_{rate}}$$

When the synchronisation timeout is disabled, the apparatus may remain in the network after its first successful synchronisation.

Synchronisation timeout may help mitigate oscillator clock drift by forcing the apparatus to acquire synchronisation again.

The number of transmitters (also called multiple/single synchronisation nodes) refers to the number of hailers, master-hailers and masters present within the network. In some embodiments, the number of transmitters may be a binary setting, such as a toggle between multiple or single transmitters. If a network only contains a single synchronisation transmitting apparatus (hailer, master-hailer or master), then the single synchronisation node is selected in the network setup. This may ensure that the synchronisation transmitting apparatus does not synchronise but may still communicate in the network (and thus will not be removed from the network). If there is more than one synchronisation transmitting apparatus, the synchronisation transmitting apparatuses may be synchronised to one another to ensure the synchronisation information propagates through the entire network.

The configuration receiving component (112) may therefore be arranged to receive one or more of the above-described configuration parameters. The configuring component (111) may be arranged to configure the apparatus according to the configuration parameters. The configuration parameters may be received by the configuration receiving component (112) from a user, such as a network user having network access to a plurality of apparatuses including the apparatus or an operator of the apparatus who is physically before the apparatus in question. The configuration parameters may be received by the configuration receiving component (112) from the user through the configuration interface, which may include one or both of a user interface and a network interface. The configuration interface may be in data communication with the configuration receiving component (112) and/or the configuring component, and may include any suitable interface components by which a network user or an operator may input and/or view configuration settings. The user interface may for example include buttons, dials, a keypad, touchpad, touch screen, LCD, LED, OLED screen or the like. The network interface may be a component which processes an incoming signal containing the parameters into instructions or for storage in memory.

The configuring component (111) may be arranged to configure the apparatus by saving or storing the configuration parameters in or to a configuration data structure (111A). The configuration data structure (111A) may for example be a configuration file (e.g., a synchronisation configuration file) or other suitable data structure. The configuration data structure (111A) may be stored in memory (110) and may be accessible to the processor (108) when executing time synchronisation operations according to aspects of the present disclosure.

The occurrence detecting component (114) may be arranged to detect occurrence of the synchronisation event. The occurrence detecting component (114) may include a time-based event detecting component (115) and an operation-based event detecting component (117). The time-based event detecting component (115) may be arranged to detect a time-based event, which is a synchronisation event. The operation-based event detecting component (117) may be arranged to detect an operation-based event, which is a synchronisation event. The time-based event detecting component (115) and the operation-based event detecting component (117) may be simultaneously operational, depending on the configuration of the apparatus.

If a synchronisation event is a time-based event, detecting occurrence of the synchronisation event may include detecting that the period of time associated with the time interval event has expired. The apparatus may include a timer (106) for detecting the expiry of the period of time associated with the time interval event. The timer (106) may repeatedly time the period of time. The time-based event detecting component (115) may monitor or be interruptible by the timer (106) to detect occurrence of the time-based event.

The synchronisation information transmitting component (116) may be arranged to transmit synchronisation information. Transmission may be via the transceiver (102). The synchronisation information may be transmitted to another apparatus operating in a receiving mode. Transmitting may be in response to detecting occurrence of the synchronisation event. The synchronisation information may be usable by the synchronisation receiving apparatus for time synchronisation.

Synchronisation information may be included in a packet. An exemplary structure (200) of a packet for time synchronisation can be seen in FIG. 2. The packet may for example include one or more of an authentication vector (AV₁→AV₄); a time vector (TV₁→TV₇); a packet header (PH); clock synchronisation timing (Sync); and a cyclic redundancy check (CRC).

The authentication vector (AV₁→AV₄) may be used by the receiving apparatus to authenticate the incoming packet. In some embodiments, the receiving apparatus may check if a copy of the authentication vector has already been stored in memory. If a copy is found, indicative of a replay attack, the receiving apparatus may ignore or disregard the packet. If a copy of the authentication vector is not found, the receiving apparatus may authenticate the packet. The receiving apparatus may then use the provided synchronisation information for synchronising its clock and may store the received authentication vector in memory so that the authentication vector may not be used again.

The clock synchronisation timing (Sync) may indicate a time stamp to be used for synchronisation. Clock synchronisation timing (Sync) may be a value from a reference time system; for example a Unix time stamp or other value based on a reference system such as the Coordinated Universal Time (UTC) reference system, a timestamp based on a GPS time value, or the like.

Since the synchronisation information may be broadcast in bursts over multiple synchronisation channels, an apparatus may receive the synchronisation information at different times. To compensate for the different receiving times, the apparatus may use one of the provided time vectors (TV₁→TV₇) together with the clock synchronisation timing (Sync) to obtain the correct synchronisation information. The one or more time vectors may for example include time offset information. In some embodiments, the time offset information included in the time vectors may include a numbering of the particular burst in a TBS (for example, first burst, second burst, etc.). In some embodiments, for example, if a receiving apparatus receives synchronisation information on a second channel, the apparatus may use the second time vector (TV₂) to offset the Sync value and obtain the relevant time stamp for synchronisation.

It should be appreciated that different embodiments may include packets of different sizes, arrangements and required transmission times. In the illustrated example, the packet header (PH) comprises 64 bits; the clock synchronisation timing (sync), 8 bits, the authentication vector (AV₁→AV₄), 32 bits; the time vector (TV₁→TV₇), 56 bits; and the cyclic redundancy check (CRC), 16 bits, resulting in a 176-bit transmission with an estimated transmission time of 115 milliseconds.

Returning to FIG. 1B, the synchronisation information receiving component (120) may be arranged to receive synchronisation information usable by the apparatus (100) for time synchronisation when the apparatus (100) is operating as a synchronisation receiving apparatus (or in a synchronisation receiving mode). The synchronisation information may be received, via the transceiver (102), from another apparatus operating as a synchronisation transmitting apparatus.

The verifying component (122) may be configured to authenticate the received synchronisation information. Authenticating the received synchronisation information may be by verifying an authentication vector included in a time synchronisation packet. The synchronisation information may be received in the time synchronisation packet, and the verifying component (122) may include an extracting component (124) for extracting an authentication vector from the time synchronisation packet. In some embodiments, the time synchronisation packet may include a random number and the authentication vector.

The verifying component (122) may include a comparing component (128) for comparing the extracted authentication vector to another value used in authentication. For example, the comparing component (128) may compare the authentication vector to previously-received authentication vectors stored in memory (e.g. by searching for matching or corresponding authentication vectors received previously).

The verifying component (122) may further include a storing component (129) for storing the authentication vector in memory.

The verifying component (122) may include a calculating component for calculating an authentication vector. Calculating the authentication vector may use one or more of a key and a hash algorithm. Calculating the authentication vector may include encrypting the random number using the key. Calculating the authentication vector may include performing a hash operation on the random number. In some embodiments, calculating the authentication vector includes performing a hash operation on the random number having been encrypted using the key. The verifying component may further include a comparing component for comparing the calculated authentication vector and the extracted authentication vector.

The verifying component may include a confirmation component for confirming an authentication vector as verified if one or more of the following conditions are met: if the calculated and extracted authentication vectors match; and, if the extracted authentication vector has not previously been stored in memory (indicating that it is not from a replayed message), the received synchronisation information may be considered authenticated and suitable for use in synchronisation. In some embodiments, the verifying component may also check the synchronisation information or packet for errors. Errors may have occurred in the transmission, or by other factors.

The synchronising component (130) may be arranged to synchronise the clock system (104) or a local clock based on the received synchronisation information. The apparatus may have authenticated the received synchronisation information before using the information for synchronisation.

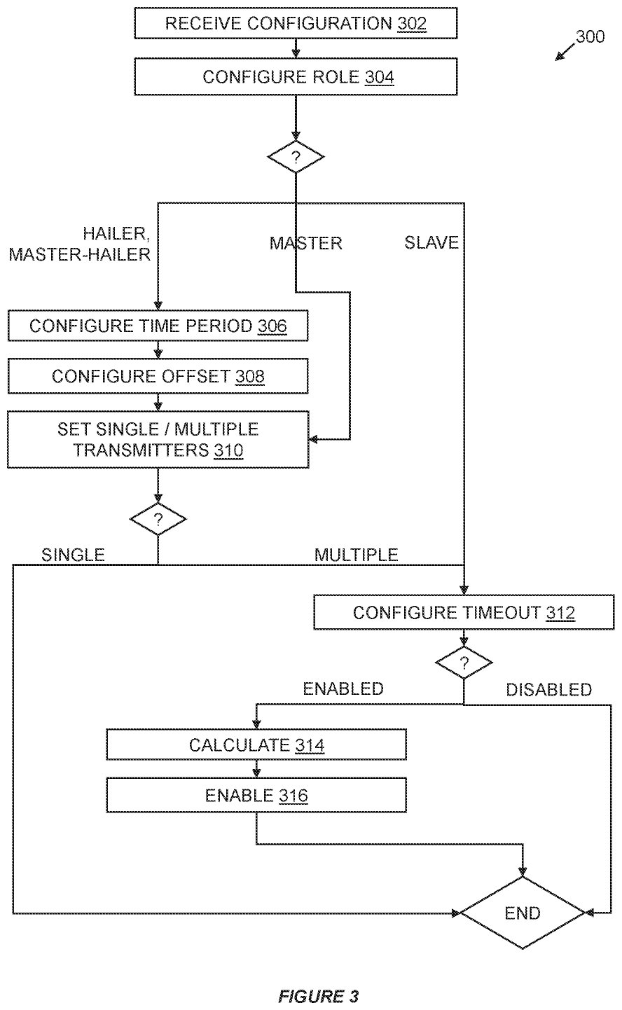

FIG. 3 is a flow diagram illustrating an exemplary configuring (300) of an apparatus according to aspects of the present disclosure. An apparatus may receive (302) configuration. Configuration may include settings chosen by the network user, an operator or the like. Configuration may be according to received parameters, some or all of which may relate to top-level configuration of the network set by a network administrator. Some parameters may be reconfigured in the field, for example the role of the apparatus may be switched in the field between: slave; master; hailer; and, master-hailer. In some embodiments, receiving configuration may include receiving a plurality of parameters to be configured. In other embodiments, receiving configuration may include receiving one or more parameters. Configuring may occur upon receipt of any number of parameters, depending on the embodiment. As an example, in one embodiment, an apparatus may receive a parameter, which is then used for configuration before receiving another parameter. In another embodiment, as in the one shown in FIG. 3, the apparatus may receive a plurality of parameters before beginning configuration. In some embodiments, the apparatus may configure itself. In other embodiments, the apparatus may be configured by an external source of configuration.

Configuration may set the role of the apparatus. Configuring may therefore include configuring (304) the apparatus according to the role that has been selected for it. This may include instructing the apparatus to switch between a communication mode and one or both of a synchronisation transmitting mode and a synchronisation receiving mode, based on detection of events or timeouts.

In case of the apparatus being configured to switch between a communication mode and a synchronisation transmitting mode (and optionally a synchronisation receiving mode as well), configuring may include receiving configuration to monitor a synchronisation event selected from: a time-based event; and, an operation-based event. Such an apparatus may be a master, a hailer, or a master-hailer depending on the configuration received. Alternatively, the apparatus may receive configuration to switch between a communication mode and a synchronisation receiving mode only, thus configuring the apparatus to receive synchronisation information as a slave.

As previously described, an operation-based event may include a transmission event. The transmission event may include a communication transmission via a transceiver. The time-based event may include a time interval event. Receiving configuration to monitor the synchronisation event may include receiving configuration of a period of time associated with the time interval event.

If the apparatus is configured to monitor a time-based event, such as a hailer or a master-hailer, configuring may include configuring (306) a period of time associated with the time interval event. Configuring may further include configuring (308) an offset. The period of time may indicate how often the apparatus is to transmit synchronisation information. The offset may indicate when or at which time stamp the apparatus is to transmit the synchronisation information. If the apparatus is configured as a synchronisation transmitting apparatus such as a hailer, master, or master-hailer, configuring may include configuring (310) whether there are one (single) or more than one (multiple) synchronisation transmitting apparatuses envisioned for the system. If the system includes a single synchronisation transmitting apparatus and there are no further settings to be configured, the configuring (300) may end, or be complete. If the system includes multiple synchronisation transmitting apparatuses, or if the apparatus is a slave, configuring may include configuring (312) a timeout setting. If timeout is enabled, configuring may include calculating (314) the required time out. Calculations may be based on the hop rate. Configuring may further include enabling (316) the timeout setting according to the calculation. Enabling (316) the timeout setting may include configuring and/or activating a timer for monitoring the timeout. If the timeout configuration is complete or if timeout is disabled and there are no further settings to be configured, the configuring may be complete. Configuring each of the parameters of the configuration steps (304, 306, 308, 310, 312, 314, 316) may include storing or saving these parameters in a configuration data structure (111A) stored in memory (110).

Once configuration is complete, the configured apparatus or apparatuses may be ready for entry into the network and a network may be initiated. Initial network synchronisation may require an apparatus configured as a hailer to transmit synchronisation information once on all synchronisation channels, which may allow enough time for all apparatuses to lock into the network. As soon as an apparatus configured as a hailer or master-hailer is synchronised it may activate an immediate hail sequence with a random time offset from its synchronisation time stamp. In other words, once an apparatus has been synchronised, it may begin transmitting synchronisation information. If the apparatus is configured as a hailer or a master-hailer, transmitting may occur upon detecting a time-based event. The synchronisation event may be a time stamp representing an offset from the time stamp of its synchronisation or the expiry of a time interval after the offset. This may ensure fast synchronisation for big networks.

If an apparatus was not part of an initial setup of a network, the apparatus may enter the network by receiving synchronisation information from a hailer or by receiving synchronisation information from a transmit sequence of a current hopping network via a master-hailer or a master. The late entry time may be influenced by the network setup parameters as previously described.

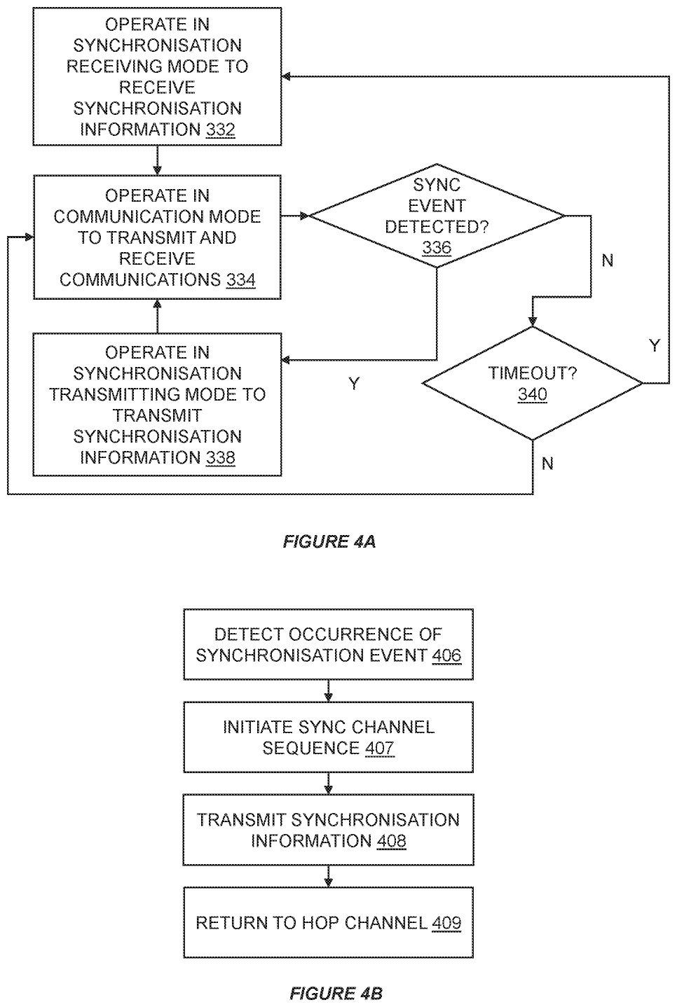

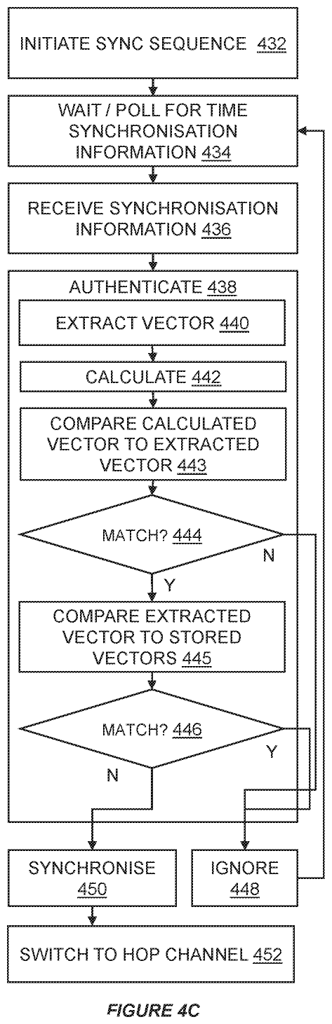

FIG. 4A is a flow diagram which illustrates an example method for time synchronisation across a network according to aspects of the present disclosure. The method may be conducted by an apparatus, such as the apparatus (100) described in the foregoing.

The apparatus (100) may operate (332) in a synchronisation receiving mode to receive synchronisation information from another apparatus in the network via a synchronisation channel.

Responsive to receiving synchronisation information, the apparatus may use the synchronisation information to join the network and switch to operate (334) in a communication mode to transmit and receive communication transmissions to and from other apparatuses in the network via a hop channel.

Depending on the configuration of the apparatus, while operating in the communication mode, the apparatus (100) may monitor for and may detect (336) occurrence of a synchronisation event based on the configuration of the apparatus.

Depending on the configuration of the apparatus (100), the synchronisation event may be one of a time-based event or an operation-based event. In the case of detection of a time interval event, detecting (336) occurrence of the synchronisation event may include detecting that a period of time associated with the time interval event has expired. Detecting that the period of time associated with the time interval event has expired may include using a timer which repeatedly times the period of time.

If the apparatus detects occurrence of a synchronisation event, the apparatus (100) may switch to operate (338) in a synchronisation transmitting mode to transmit synchronisation information to other apparatuses in the system. Once transmission of the synchronisation information is complete, the apparatus (100) may return to operating (334) in the communication mode to transmit and receive communication transmissions to and from other apparatuses in the network via a hop channel.

Depending on the configuration of the apparatus, the apparatus may continue to operate in the communication mode until a timeout is detected (340). The timeout may be based on the time at which the apparatus joined the network (i.e. it may not be reset each time a synchronisation event is detected).

If timeout is enabled, the apparatus may monitor for timeout. While no timeout is detected (i.e. timeout has not been reached or exceeded), the apparatus may continue to operate (334) in the communication mode to transmit and receive communication transmissions. The apparatus may therefore operate in the communication mode to transmit and receive communication transmissions to and from other apparatuses in the network via a hop channel until a synchronisation event is detected (if so configured) or until a timeout (if so configured).

If the timeout is detected (i.e. timeout has been reached or exceeded), the apparatus (100) may leave, be removed from or “lock itself out of” the network and switch to operate (332) in the synchronisation receiving mode to receive synchronisation information from another apparatus in the network via a synchronisation channel.

Depending on configuration, the apparatus may initiate the method by operating in any one of: the synchronisation transmitting mode, the synchronisation receiving mode, or the communication mode. The method may repeat for as long as the apparatus is operational.

FIG. 4B is a flow diagram which illustrates an example method performed by an apparatus, such as the apparatus (100) described in the foregoing, while operating in a synchronisation transmitting mode.

As mentioned, in regular use, the apparatus (100) may transmit and receive communication transmissions to and from other apparatuses in the network via a hop channel. The method may include monitoring for detection of a synchronisation event. The method may include detecting (406) occurrence of the synchronisation event which, depending on the configuration of the apparatus, may be one or both of a time-based event or an operation-based event.

The method may include initiating a synchronisation channel sequence (407). Initiating the synchronisation channel sequence may be in response to detecting the synchronisation event. Initiating a synchronisation channel sequence may include switching from the hop channel to a synchronisation channel. The apparatus may switch between a number of synchronisation channels in a sequence, for example as described in greater detail below with reference to FIG. 5. The sequence may be predetermined.

The method may include transmitting (408) synchronisation information usable by another apparatus (e.g., a synchronisation receiving apparatus) for time synchronisation. Transmitting (408) synchronisation information may be in response to detecting (406) the occurrence of the synchronisation event. Transmitting the synchronisation information may be via one or more synchronisation channels. The one or more synchronisation channels may be discrete from a hop channel via which communication transmissions are transmitted or received. Transmitting the synchronisation information may include transmitting a packet including the synchronisation information.

In some embodiments, transmitting the synchronisation information includes transmitting a transmit burst sequence (TBS) in which the synchronisation information is transmitted once via each of a plurality of synchronisation channels. Each transmission of synchronisation information is termed a “burst” and, in some embodiments, may include transmission of a time synchronisation packet which includes the time synchronisation information. A TBS may therefore include the transmission of a series of bursts, each burst being transmitted one after the other via a different synchronisation channel. In some embodiments, transmitting the synchronisation information includes transmitting a TBS repeatedly a predetermined number of times.

An exemplary sequence (500) used to transmit synchronisation information is shown in FIG. 5. In this example, a TBS consists of eight “bursts” (in which synchronisation information is transmitted, each on a different synchronisation channel). There is a sequence of eight TBSs following each other sequentially. Each TBS contains a 125-millisecond burst on every synchronisation channel, which makes 1 TBS with a 1 second duration. This is repeated 8 times to give 8 TBSs in a sequence with a total duration of 32 seconds, inclusive of dwell time. Such a sequence may be transmitted by a hailer, master-hailer or master.

The method may include returning (409) to a hop channel for continued transmission/reception of communication transmissions via the hop channel until a next synchronisation event or a timeout is detected (depending on the configuration).

FIG. 4C is a flow diagram which illustrates an example method performed by an apparatus, such as the apparatus (100) described in the foregoing, while operating in a synchronisation receiving mode.

The method may include initiating (432) a synchronisation sequence by switching to a synchronisation channel.

The method may include waiting, scanning or polling (434) for synchronisation information. Scanning or polling for synchronisation information may include switching through one or more synchronisation channels via which synchronisation information might be received. This may include switching through the channels in a predetermined sequence.

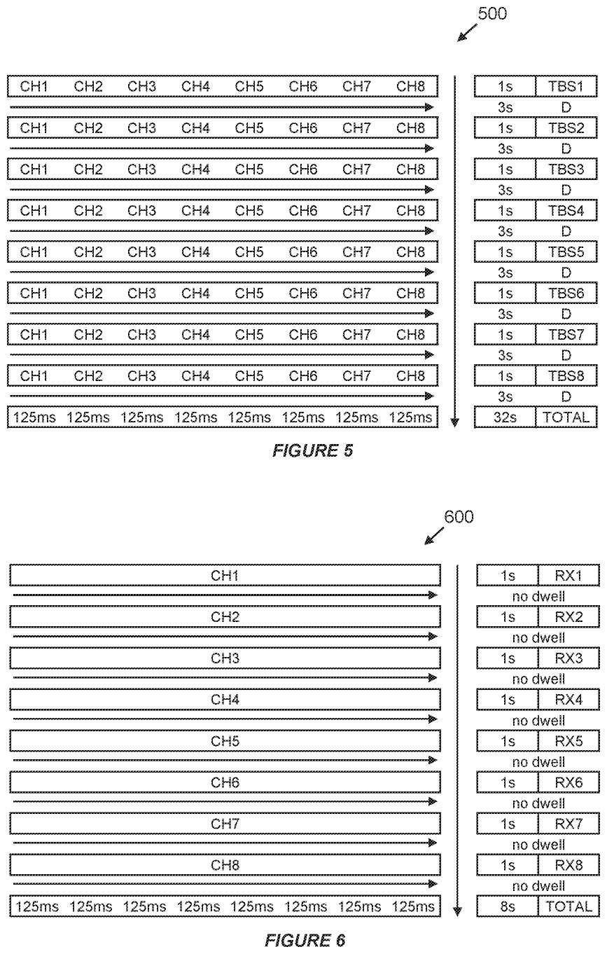

FIG. 6 is a diagram which shows an exemplary sequence (600) used to scan for synchronisation information across multiple channels (in this example, eight are illustrated). Scanning for synchronisation information may include dwelling on a synchronisation channel for a dwell period (for example, for one second). If no valid data is received, the method includes moving to the next synchronisation channel and waiting for valid data for a dwell period. The method may continue scanning on each of the one or more synchronisation channels in this manner until the last synchronisation channel is reached and may then repeat to start from the first synchronisation channel again. Scanning or polling may repeat until the synchronisation information is received.

It should be appreciated that the number of bursts, channels, repetitions, dwell times and durations shown in FIGS. 5 and 6 are purely illustrative and may vary in different embodiments.

Returning to FIG. 4C, the method may include receiving (436) the synchronisation information. The synchronisation information may be included in a packet and receiving the synchronisation information may include receiving a packet containing the synchronisation information. The synchronisation packet may include one of both of an authentication vector and a random number.

The method may include authenticating (438) the synchronisation information or packet, for example using the authentication vector, to verify that the sender is not a spoofing radio. Authenticating (438) may include extracting (440) the authentication vector from the packet. Authenticating (438) may include calculating (442) an authentication vector using one or both of a key and a hashing algorithm. Calculating the authentication vector may include encrypting the random number using the key. Calculating the authentication vector may include performing a hash operation on the random number using the hash algorithm. In some embodiments, calculating the authentication vector includes performing a hash operation on the random number having been encrypted using the key. Authenticating (438) may include comparing (443) the extracted vector to the calculated vector. If the extracted authentication vector does not match (444) or correspond to the calculated authentication vector, the synchronisation information or packet is not authenticated and the method may include ignoring (448) or discarding the information or packet. If the extracted authentication vector does match the calculated authentication vector, the authentication vector may be authenticated and the method may include synchronising (450) a local clock based on the received synchronisation information. In some cases, authenticating (438) may include comparing (445) the extracted authentication vector to vectors stored in memory. If the extracted authentication vector matches or corresponds (446) to any of the authentication vectors stored in memory, the synchronisation information or packet is not authenticated and the method may include ignoring or discarding (448) the information or packet. If the extracted authentication vector does not correspond (446) to any stored values, the authentication vector is authenticated and the method may include synchronising (450) a local clock based on the received synchronisation information. The method may also include storing the authentication vector so that once an authentication vector is stored it cannot be used again, preventing message playback. Some embodiments may further provide for the clearing of stored authentication vectors after certain conditions are met. Authenticating (438) may include checking a time and/or date stamp included in the synchronisation information or packet and comparing this to the current time and/or date to prevent old messages from being used for synchronisation. The authenticating steps described above may be performed serially in any order such that the extracted authentication vector might first be checked to see if it corresponds to one stored in memory and then checked to see if it matches a calculated authentication vector, or vice versa. Authenticating (438) may include confirming an authentication vector as verified if one or more of the following conditions are met: the calculated and extracted authentication vectors match; and, the extracted authentication vector has not previously been stored in memory.

Once the apparatus has been synchronised, the method may include switching (452) to the hop channel for transmitting and receiving communication transmissions via the hop channel.

FIGS. 4A to 4C illustrate exemplary embodiments of a method for time synchronisation. However, various further embodiments of the method and system may be derived according to how the apparatuses are configured within the network. For example, a master/slave hopping network (also a hailer/slave network); an all-master network; and a combined master/slave network (also termed an all-role network) may be provided.

In a hailer/slave system, the initial network setup includes one or more synchronisation transmitting apparatuses configured to monitor a time-based synchronisation event (hailers or master-hailers) and slave apparatuses waiting to be synchronised into the network. The synchronisation transmitting apparatus may be set up to transmit synchronisation information at a time interval (for example, every 60, 30, 15, or 5 minutes) according to the network setup parameters. Once a slave receives the synchronisation information, the slave apparatus may enter or “lock into” the network. The slave apparatus's time may be synchronised to the synchronisation transmitting apparatus's time and clock. Any apparatus can accept the role of becoming the synchronisation transmitting apparatus according to the network setup parameters. An advantage of this network configuration may be that a late entry may be ensured due to the repeated transmission of the synchronisation transmitting apparatus. However, a disadvantage may be that the synchronisation transmitting apparatus might become a target for jammers and direction finders because of its repeated transmissions.

In an all-master system, all OTAHS masters may by default transmit a synchronisation packet after each transmission on the hopping frequency channel (for example, after each voice transmission). The master may transmit synchronisation information for a time interval (for example, two seconds), creating a number of transmit bursts (for example two transmit bursts) on the synchronisation channels before returning to the hop channel. Apparatuses that are part of the network may resynchronise after each transmission over the synchronisation channels. This may ensure less clock drift and longer network timing synchronisation as long as there is communication on the network. Late entry is also ensured because of the ad-hoc transmission of synchronisation information by masters. The all-master network does not require a master hailing apparatus but has the disadvantage of late entry being dependent on the communication on the network. Thus, it might take long for a late entry. A possible advantage of this network setup is potentially being less prone to jamming and more difficult to detect by direction finders because there will only be transmission when needed.

In a combined master/slave system, a combination of a hailer/slave system and an all-master system is also possible. In this system, apparatuses may be hailers, master-hailers, masters and/or slaves. The hailing apparatuses may be configured to transmit synchronisation information at different time stamps. The period between transmissions of synchronisation information by hailers and/or master-hailers may be long (hailing, for example, every 60 minutes). This system may be characterised by space and time diversity, ensuring faster late entry while potentially making jamming and direction finding more challenging for the adversary.

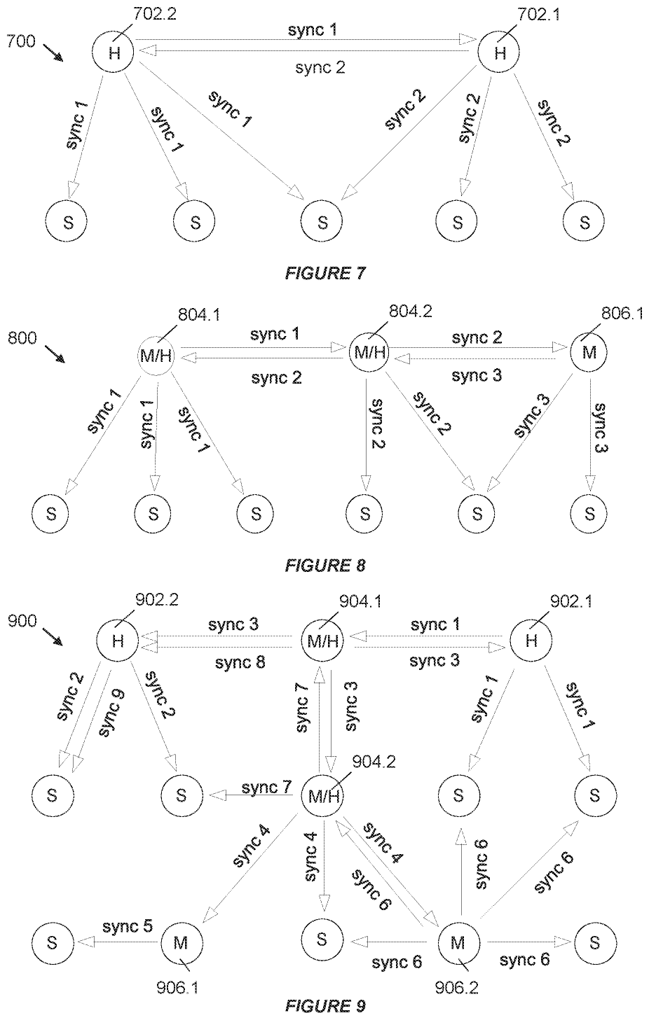

FIGS. 7 to 9 provide exemplary systems and synchronisation sequences according to different configurations. Each example depicts a number of hailers (H), master-hailers (M/H), masters (M) and slaves(S); however, it should be appreciated that the composition of the system and the synchronisation transmissions are only for illustrative purposes. The figures each only indicate an exemplary initial network synchronisation; many others may be possible.

FIG. 7 illustrates an exemplary embodiment of a “hailer/slave” system (700). A first hailer (702.1) synchronises several of the slaves and a second hailer (702.2) in “sync 1”, which in turn synchronises a number of slaves and the first hailer (702.1) in “sync 2”.

FIG. 8 shows an exemplary embodiment of a “master-hailer, master, slave” system (800). A first master-hailer (804.1) synchronises a number of slaves and a second master-hailer (804.2) in “sync1”, while the second master-hailer (804.2) in turn synchronises a number of slaves, the first master-hailer (804.1) and a master (806.1) in “sync 2”. The master (806.1) in turn synchronises a number of slaves and the second master-hailer (804.2) in “sync 3”.

FIG. 9 shows an exemplary embodiment of a “hailer, master-hailer, master, slave” system (900). A first hailer (902.1) synchronises a number of slaves and a first master-hailer (904.1) in “sync 1”, and a second hailer (902.2) synchronises a number of slaves in “sync 2.” The first master-hailer (904.1) then synchronises both hailers (902.1, 902.2) and a second master-hailer (904.2) in “sync 3”. The second master-hailer (904.2) then synchronises a number of masters (906.1, 906.2) and slaves in “sync 4”, which in turn each synchronise a number of slaves in “sync 5” and “sync 6.” One of the masters (906.2) also synchronises the second master-hailer (904.2) in “sync 6”, which then synchronises the first master-hailer (904.1) and a slave in “sync 7”. The first master hailer (904.1) again synchronises the first hailer (902.1) in “sync 8”, which synchronises a slave in “sync 9”.

Aspects of the present disclosure provide for an apparatus, system and method for time synchronisation which may balance ease of joining the network while increasing the difficulty for targeting by jammers or direction finders. This is achieved by providing configuration of the apparatuses as either or both of hailers and masters. The configuration allows for a plurality of masters, a plurality of hailers and a plurality of master-hailers within a network. Moreover, there may also be a plurality of slaves which receive synchronisation information from the masters, hailers or master-hailers.

Aspects of the present disclosure may further allow apparatuses to be reconfigured as needed. For example, a slave may be reconfigured as a master, hailer or master-hailer; a hailer as a master, etc. Allowing for adaptable configuration may preserve the network if some apparatuses are damaged or lost.

Providing hailers configured with a relatively long hailing interval as well as masters ensures that synchronisation can happen in cases where radio activity is low without overexposing the network to jamming or detection by direction finders.

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

Any of the steps, operations, components or processes described herein may be performed or implemented with one or more hardware or software units, alone or in combination with other devices. Components or devices configured or arranged to perform described functions or operations may be so arranged or configured through computer-implemented instructions which implement or carry out the described functions, algorithms, or methods. The computer-implemented instructions may be provided by hardware or software units. In one embodiment, a software unit is implemented with a computer program product comprising a non-transient or non-transitory computer-readable medium containing computer program code, which can be executed by a processor for performing any or all of the steps, operations, or processes described. Software units or functions described in this application may be implemented as computer program code using any suitable computer language such as, for example, Java™, C++, or Perl™ using, for example, conventional or object-oriented techniques. The computer program code may be stored as a series of instructions, or commands on a non-transitory computer-readable medium, such as a random-access memory (RAM), a read-only memory (ROM), a magnetic medium such as a hard-drive, or an optical medium such as a CD-ROM. Any such computer-readable medium may also reside on or within a single computational apparatus, and may be present on or within different computational apparatuses within a system or network.

Flowchart illustrations and block diagrams of methods, systems, and computer program products according to embodiments are used herein. Each block of the flowchart illustrations and/or block diagrams, and combinations of blocks in the flowchart illustrations and/or block diagrams, may provide functions which may be implemented by computer readable program instructions. In some alternative implementations, the functions identified by the blocks may take place in a different order to that shown in the flowchart illustrations.

Some portions of this description describe the embodiments of the invention in terms of algorithms and symbolic representations of operations on information. These algorithmic descriptions and representations, such as accompanying flow diagrams, are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention set forth in any accompanying claims.

Finally, throughout the specification and any accompanying claims, unless the context requires otherwise, the word ‘comprise’ or variations such as ‘comprises’ or ‘comprising’ will be understood to imply the inclusion of a stated integer or group of integers but not the exclusion of any other integer or group of integers.

1. An apparatus comprising:
a configuration receiving component for receiving configuration of the apparatus to monitor a synchronisation event selected from: a time-based event; and, an operation-based event;
a configuring component for configuring the apparatus to monitor the selected synchronisation event;
an occurrence detecting component for detecting occurrence of the selected synchronisation event; and
a synchronisation information transmitting component for, in response to detecting occurrence of the selected synchronisation event, transmitting synchronisation information usable for time synchronisation by another apparatus.

2. The apparatus as claimed in claim 1, wherein the configuration receiving component receives the configuration from a user, wherein the user is a network user having network access to a plurality of apparatuses including the apparatus or an operator of the apparatus who is physically before the apparatus.

3. The apparatus as claimed in claim 1, including:
a synchronisation information receiving component for receiving synchronisation information usable for time synchronisation; and
a synchronising component for synchronising a local clock based on the received synchronisation information.

4. The apparatus as claimed in claim 1, wherein the operation-based event includes a transmission event, wherein the transmission event includes a communication transmission via a transceiver.

5. (canceled)

6. The apparatus as claimed in claim 1, wherein the time-based event includes a time interval event, and wherein the configuring component configures the apparatus to monitor a period of time associated with the time interval event.

7. The apparatus as claimed in claim 6, wherein the configuration receiving component is further arranged to receive configuration of a period of time associated with the time interval event.

8. The apparatus as claimed in claim 6, wherein the occurrence detecting component is arranged to detect that the period of time associated with the time interval event has expired.

9. The apparatus as claimed in claim 6, including a timer for detecting the expiry of the period of time associated with the time interval event, wherein the timer repeatedly times the period of time.

10. The apparatus as claimed in claim 1, wherein the synchronisation information is included in a time synchronisation packet, wherein the time synchronisation packet includes an authentication vector configured for verification.

11. The apparatus as claimed in claim 1, wherein transmitting the synchronisation information includes transmitting the synchronisation information via one or more synchronisation channels.

12. The apparatus as claimed in claim 11, wherein the one or more synchronisation channels are discrete from a hop channel via which communication transmissions are transmitted or received.

13. A system including two or more apparatuses as claimed in claim 1, wherein a first apparatus of the two or more apparatuses is configured to monitor a time-based event and wherein a second apparatus of the two or more apparatuses is configured to monitor an operation-based event.

14. The system as claimed in claim 13, including a third apparatus configured to monitor a time-based event and an operation-based event.

15. The system as claimed in claim 13, including a fourth apparatus, wherein the fourth apparatus is configured to monitor a time-based event, and wherein:
the first apparatus receives configuration of a first period of time associated with a time interval event; and,
the fourth apparatus receives configuration of a second period of time associated with a time interval event, wherein the first and second periods of time are different.

16. A computer-implemented method comprising:
receiving configuration of an apparatus to monitor a synchronisation event selected from: a time-based event; and, an operation-based event;
configuring the apparatus to monitor the selected synchronisation event;
detecting occurrence of the selected synchronisation event; and
in response to detecting the occurrence of the selected synchronisation event, transmitting synchronisation information usable for time synchronisation by another apparatus.

17. The method as claimed in claim 16, wherein the operation-based event includes a transmission event, wherein the transmission event includes a communication transmission via a transceiver.

18. (canceled)

19. The method as claimed in claim 16, wherein the time-based event includes a time interval event, the method including configuring the apparatus to monitor a period of time associated with the time interval event.

20. (canceled)

21. The method as claimed in claim 19, including receiving configuration of a period of time associated with the time interval event and, wherein detecting occurrence of the selected synchronisation event includes detecting that the period of time associated with the time interval event has expired, wherein detecting that the period of time associated with the time interval event has expired includes using a timer which repeatedly times the period of time.

22. (canceled)

23. The method as claimed in claim 16, wherein the synchronisation information is included in a time synchronisation packet, wherein the time synchronisation packet includes an authentication vector configured for verification by the receiving apparatus, and wherein the method includes authenticating the synchronisation information using the authentication vector.

24. The method as claimed in claim 16, including transmitting the synchronisation information via one or more synchronisation channels, wherein the one or more synchronisation channels are discrete from a hop channel via which communication transmissions are transmitted or received.
